(19) United States
(12) Patent Application Publication
(10) Pub. No.: US 2022/0379518 A1
(43) Pub. Date: Dec. 1, 2022

(54) HYDRAULIC LOG SPLITTER

(71) Applicant: INTRADIN (HUZHOU) PRECISION TECHNOLOGY CO.,LTD., Zhejiang (CN)

(72) Inventors: Ping LI, Zhejiang (CN); Chenliang YUAN, Zhejiang (CN); Gaofeng WANG, Zhejiang (CN)

(73) Assignee: INTRADIN (HUZHOU) PRECISION TECHNOLOGY CO.,LTD., Zhejiang (CN)

(21) Appl. No.: 17/358,569

(22) Filed: Jun. 25, 2021

(30) Foreign Application Priority Data
May 25, 2021 (CN) 202121132756.3

(51) Int. Cl. B27L 7/06

(52) U.S. Cl. CPC B27L 7/06

(57) ABSTRACT

A hydraulic log splitter, comprises a rack, a main beam, an oil tank, an oil cylinder, a cutter, and a push plate, wherein the main beam is arranged at an upper end of the rack, the oil tank is arranged inside the main beam, one end of the main beam is connected to the rack, the other end of the main beam protrudes from the rack, the main beam is recessed inward to form a reinforcing rib structure having a V-shaped longitudinal section, the oil cylinder is arranged at one end of the main beam, the cutter is arranged at the other end of the main beam, the push plate is arranged between the cutter and the oil cylinder, the push plate is connected to a push rod of the oil cylinder.

### BACKGROUND OF THE INVENTION

### 1. Field of the Invention

The invention relates to the technical field of log splitters, and more particularly, to a hydraulic log splitter.

### 2. Description of the Related Art

Hydraulic log splitter is one of the major auxiliary equipments in the wood processing industry. Vertical and horizontal hydraulic log splitters are common ones in the market. The primary function of the hydraulic log splitter is to drive a cutter thereof by using a hydraulic system to split tree stumps, large tree stumps, large logs and other relatively hard wood, cutting wood into a required size for other purposes.

The log splitter in the prior art is hard to move due to its relatively large overall weight. In addition, the rack of the log splitter is separated from the oil tank, so the rack may slide relative to the oil tank. When in use, at least two people are needed to perform installation and debugging of the log splitter, so it is difficult to operate.

### SUMMARY OF THE INVENTION

One object of the invention is to provide a hydraulic log splitter for solving the above-mentioned technical problems.

The technical solution for the invention is as follows:

a hydraulic log splitter, comprising a rack, a main beam, an oil tank, an oil cylinder, a cutter, a push plate and a rib structure, wherein the main beam is arranged at an upper end of the rack, the oil tank is arranged inside the main beam, one end of the main beam is connected to the rack, the other end of the main beam protrudes from the rack, an upper surface of the main beam is recessed inward to form a reinforcing rib structure having a V-shaped longitudinal section, the oil cylinder is arranged at one end of the main beam, the cutter is arranged at the other end of the main beam, the push plate is arranged between the cutter and the oil cylinder, the push plate is connected to a push rod of the oil cylinder, the plurality of rib structures are uniformly arranged at an end of the push plate, away from the oil cylinder, the oil cylinder is fixedly secured to a lower end of the main beam, and the oil cylinder is connected to the oil tank through an oil pipe.

Preferably, the hydraulic log splitter further comprises a support leg, wherein the support leg is removably mounted at the other end of the main beam for supporting the main beam, and a non-slip mat is arranged at a lower end of the support leg.

Preferably, the hydraulic log splitter further comprises a handle, a handle connecting seat and a limiting pin assembly, wherein the handle is arranged at one end of the cutter, away from the push plate, one end of the handle is connected to the cutter through the handle connecting seat, and the limiting pin assembly is arranged at one side of the handle connecting seat.

Preferably, the hydraulic log splitter further comprises two oil cylinder mounting bases which are symmetrically and fixedly disposed on two sides of one end of the main beam, the oil cylinder is fixed to the two oil cylinder mounting bases.

Preferably, the log splitter comprises a V-shaped blade and a hemming structure arranged at two free ends of the blade.

Preferably, the log splitter further comprises a plurality of connecting plates arranged at an inner side of the blade, and two ends of each of the plurality of connecting plates are connected to the two hemming structures.

Preferably, the log splitter further comprises a filter, wherein an oil outlet is provided at the oil tank, one end of the oil pipe is connected to the oil outlet, the other end of the oil pipe is connected to the oil cylinder, and the filter is fixedly arranged at an inner side of the oil outlet.

Preferably, the log splitter further comprises a reinforcing plate and a bottom plate, wherein the reinforcing plate is arranged at the inner side of the blade, the bottom plate is arranged at a lower end of the blade, one end of the reinforcing plate is connected to the bottom plate, and the other end of the reinforcing plate is connected to one of the connecting plates.

Preferably, the log splitter further comprises a flange structure, wherein two flange structures are disposed on both sides of the main beam, a plurality of raised strips are provided in each of the two flange structures.

Preferably, the log splitter further comprises a power unit, wherein the power unit is arranged at the upper end of the rack;

wherein the power unit comprises an engine, a hydraulic pump and a connecting assembly, the engine is arranged at the upper end of the rack, the connecting assembly is sleeved on an engine shaft of the engine, and the hydraulic pump is connected to the engine shaft through the connecting assembly, and the hydraulic pump is connected to the oil tank and the oil cylinder through the oil pipe.

By adopting the above-mentioned technical solutions, the present invention has the beneficial effects that, the main beam, the oil cylinder, the oil tank and the cutter are all removably connected to the rack, and all of those components are packaged in bulk and have a light weight, so it is easy to transport; in addition, the oil tank is fixed to the main beam, and the oil tank is fixed to the rack through the main beam, therefore, it is less likely for the rack to slide relative to the oil tank; as a result, it can be operated by a single person.

### BRIEF DESCRIPTION OF THE DRAWINGS

FIG. 1 is a top view of a hydraulic log splitter according to the present invention;

FIG. 2 is the first perspective view of a hydraulic log splitter according to the present invention;

FIG. 3 is the second perspective view of a hydraulic log splitter according to the present invention;

FIG. 4 is a schematic diagram showing the structure of a cutter according to the present invention;

FIG. 5 is a schematic diagram showing the structure of a connecting assembly according to the present invention;

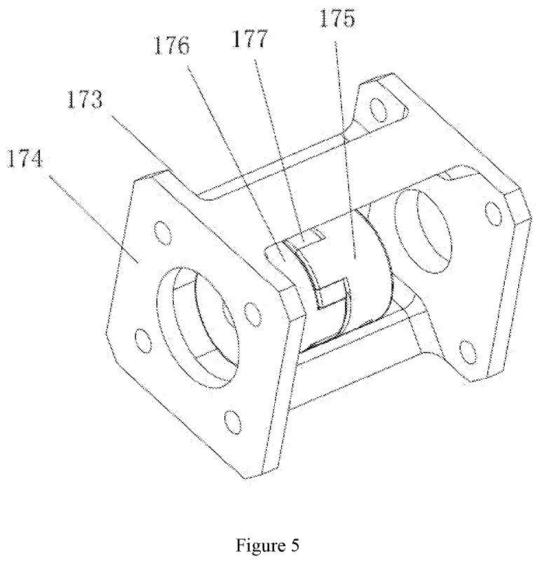

FIG. 6 is a schematic diagram showing the structure of a handle according to the present invention.

### LIST OF REFERENCE NUMERALS

1 rack of hydraulic log splitter

2 main beam

3 oil tank

4 oil cylinder

5 cutter

501 blade

502 hemming structure

503 connecting plate

504 reinforcing plate

505 bottom plate

6 push plate

7 oil pipe

8 support leg

801 non-slip mat

9 oil cylinder mounting base

10 rid structure

11 roller

12 handle

121 handle connecting seat

122 limiting pin assembly

13 non-slip sleeve

14 flange structure

15 a plurality of raised strips

16 reinforcing rib structure

17 power unit

171 engine

172 hydraulic pump

173 connecting assembly

174 fixed frame

175 first coupler

176 second coupler

177 elastic member

### DETAILED DESCRIPTION

The technical solution set forth in the embodiments of the present invention will now be described clearly and fully hereinafter with reference to the accompanying drawings of the embodiments of the present invention. Obviously, such embodiments provided in the present invention are only part of the embodiments instead of all embodiments. It should be understood that all the other embodiments obtained from the embodiments set forth in the present invention by one skilled in the art without any creative work fall within the scope of the present invention.

Throughout the description of the invention, the terms “center”, “over”, “under”, “left”, “right”, “vertical”, “horizontal”, “inner”, “outer”, and the like are intended to indicate an orientation and position as shown in Figures, and are used for descriptive purpose of the invention, and it does not necessarily indicate or imply that the device or element must have a particular orientation or it must be constructed or operated in this particular orientation. Therefore, those therms are not to be construed as a limiting to the invention. Moreover, the terms “first”, “second”, and “third” are used for descriptive purpose only and not indicative of relative importance.

Throughout the description of the invention, the terms “installed”, “connected with”, “connected to” are intended to include, for example, fixed connecting, or removably connecting, or integral connecting; or mechanical connecting, or electrical connecting; or direct connecting, or indirect connecting (in which an intermediate element is located between two elements); or communication between two elements. Those skilled in the art will recognize specific meanings of those terms in the invention.

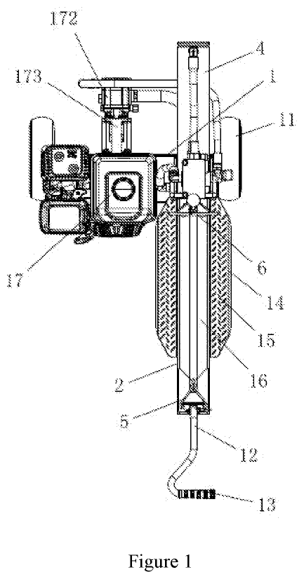

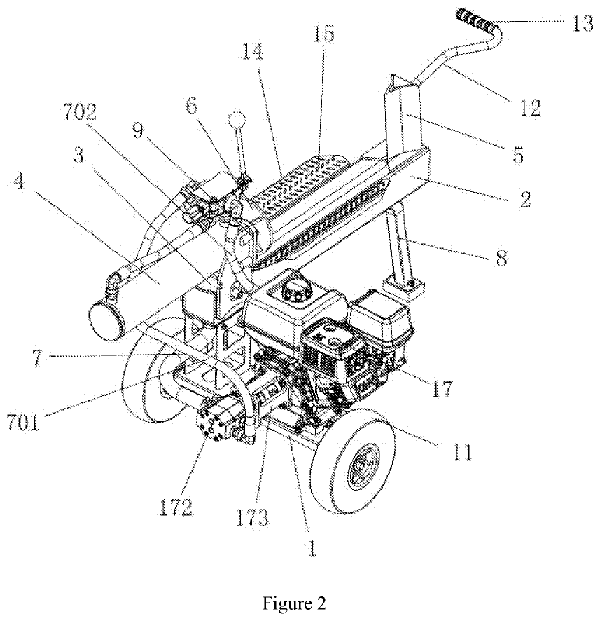

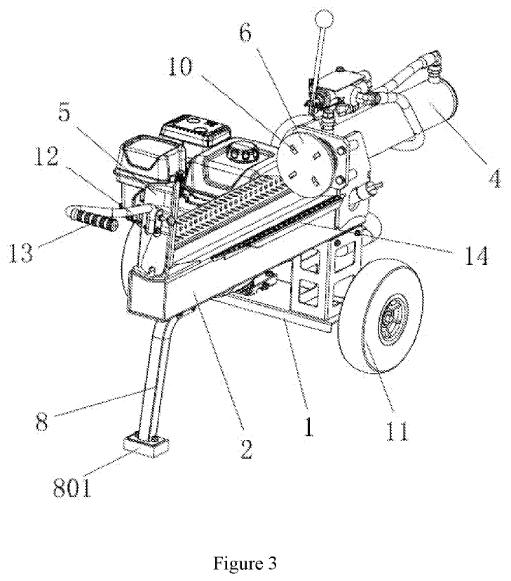

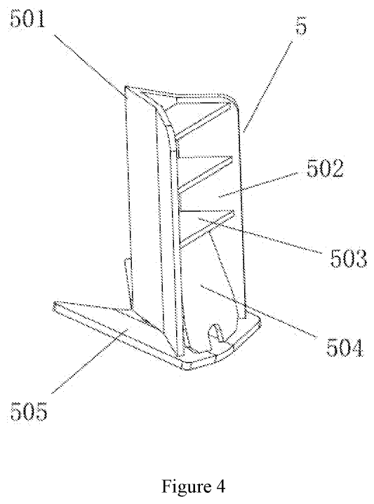

FIG. 1 is a top view of a hydraulic log splitter according to the present invention; FIG. 2 is the first perspective view of a hydraulic log splitter according to the present invention; FIG. 3 is the second perspective view of a hydraulic log splitter according to the present invention; FIG. 4 is a schematic diagram showing the structure of a cutter according to the present invention. As shown in FIGS. 1-4, a preferred embodiment is provided. A hydraulic log splitter is provided, comprising a rack 1, a main beam 2, an oil tank 3, an oil cylinder 4, a cutter 5, a push plate 6, wherein the main beam 2 is arranged at an upper end of the rack 1, the oil tank 3 is arranged inside the main beam 2, one end of the main beam 2 is connected to the rack 1, the other end of the main beam 2 protrudes from the rack 1, an upper surface of the main beam 2 is recessed inward to form a reinforcing rib structure 16 having a V-shaped longitudinal section, the oil cylinder 4 is arranged at one end of the main beam 2, the cutter 5 is arranged at the other end of the main beam 2, the push plate 6 is arranged between the cutter 5 and the oil cylinder 4, the push plate 6 is connected to a push rod of the oil cylinder 4, the oil cylinder 4 is fixedly secured to a lower end of the main beam 2, and the oil cylinder 4 is connected to the oil tank 3 through an oil pipe 7. In this embodiment, as shown in FIG. 2, the rack 1 comprises a bottom frame and a top frame, wherein the top frame is arranged at an upper end of the bottom frame, the top frame is welded and fixed to an upper end of one side of the bottom frame, the main beam 2 is fixed to the upper end of the top frame by bolts, the oil tank 3 is fixed to the top frame and is connected to the bottom of the main beam 2, so the rack 1 will not slide relative to the oil tank 3; moreover, both the main beam 2 and the oil tank 3 can be removably connected to the rack 1 for easy package and transportation. A reinforcing rib 16 is arranged at an upper surface of the main beam 2 for increasing the strength of the main beam 2, so that the main beam 2 can withstand the thrust of 18 tons. In this embodiment, a support plate is arranged at an inner side of the main beam 2, an upper end of the support plate is connected to a central portion of a bottom side of the reinforcing rib 16, a lower end of the support plate is connected to an inner wall of a lower side of the main beam 2, and the arrangement of the support plate can further increase the strength of the main beam 2. In this embodiment, an oil filler is provided at one side of the oil tank 3 for increasing the amount of oil inside the oil tank 3, and the oil in the oil tank 3 enters the oil cylinder 4, and the push plate 6 is pushed by the push rod (the piston rod of the oil cylinder 4) when the oil cylinder 4 works. The push plate 6 push the wood to move toward the cutter 5, and the cutter 5 is used to split the wood.

In a more preferred embodiment of the invention, the hydraulic log splitter further comprises a support leg 8, wherein the support leg 8 is removably mounted at the other end of the main beam 2 for supporting the main beam 2. In this embodiment, the support leg 8 is used to support the main bean 2, so as to keep the balance of the main beam 2, and the support leg 8 is removably connected to the other end of the main beam 2. In this embodiment, an elastic non-slip mat 801 is arranged at a lower end of the support leg 8. The deformation of the support leg, due to the fiction between the support leg 8 and the ground, can be avoided by arranging the non-slip mat 801 at the lower end of the support leg 8. In this embodiment, after the log splitter is moved to a required location, its support leg 8 rests on the ground, then the log splitter can be used. The log splitter in this embodiment will only need one person to operate, and it is easy to transport.

In a preferred embodiment of the invention, the hydraulic log splitter further comprises two oil cylinder mounting bases 9 which are symmetrically and fixedly disposed on two sides of one end of the main beam 2, the oil cylinder 4 is fixed to the two oil cylinder mounting bases 9. In this embodiment, the oil cylinder mounting bases 9 are fixed to the main beam 2, and the oil cylinder 4 is removably connected to the oil cylinder mounting bases 9 by bolts. The oil cylinder mounting bases 9 in this embodiment are connected to the main beam 2 by welding or by bolts. The oil cylinder mounting bases 9 in this embodiment have a plate-shaped structure, and the oil cylinder mounting bases 9 have a thickness of 8 mm.

In a preferred embodiment of the invention, the hydraulic log splitter further comprises an oil cylinder support plate (not shown in the figure). One end of each of the oil cylinder mounting base 9 is provided with the oil cylinder support plate, and the oil cylinder support plate abuts against a lower side of the oil cylinder 4. In this embodiment, the oil cylinder support plate is configured to support and fix the oil cylinder 4, which can enhance the stability of the oil cylinder 4. In this embodiment, the oil cylinder support plate is integrally connected to the oil cylinder mounting base 9.

In a preferred embodiment of the invention, a plurality of rib structures 10 are uniformly arranged at an end of the push plate 6, away from the oil cylinder 4. In this embodiment, the plurality of rib structures 10 protrudes from the push plate by 5 mm to 10 mm for clamping the wood. As shown in FIG. 3, four rib structures 10 are provided, and are in a rectangular array. The number of the rib structures 10 in this embodiment can be varied as required. Each of the rib structures 10 has a triangular shape, and each corner of the rib structure 10 points toward the cutter 5.

In a preferred embodiment of the invention, the cutter 5 comprises a V-shaped blade 501 and a hemming structure 502 arranged at two free ends of the blade 501.

In a preferred embodiment of the invention, the hydraulic log splitter further comprises a plurality of connecting plates 503 arranged at an inner side of the blade 501, and two ends of each of the plurality of connecting plates 503 are connected to the two hemming structures 502. In this embodiment, the blade 501 and the hemming structures 502 are an integral part, that is, the two free ends of the blade 501 are curved outward to form the hemming structures 502. The connecting plates 503 are connected to the inner wall of the blade 501 by welding for increasing the strength of the blade 501. The blade 501 in this embodiment is light in weight, and has a large angle, and can split the wood quickly.

In a preferred embodiment of the invention, the hydraulic log splitter further comprises a filter, wherein an oil outlet is provided at the oil tank 3, one end of the oil pipe 7 is connected to the oil outlet, the other end of the oil pipe 7 is connected to the oil cylinder 4, and the filter is fixedly arranged at an inner side of the oil outlet. In this embodiment, a plurality of fixing blocks are provided at an inner wall of the oil outlet. The plurality of fixing blocks are formed in a ring shape. The outer edge of the filter is connected to the fixing blocks by screws, and the outer edge of the filter is in interference fit with the inner wall of the oil outlet. The filter is provided to filter impurities in the hydraulic oil to protect the oil pump and to reduce maintenance costs.

In a preferred embodiment of the invention, the hydraulic log splitter further comprises a roller 11, and at least two rollers 11 are provided at a lower side of the rack 1. In this embodiment, as shown in FIG. 2, two rollers are provided at both ends of the bottom frame. The arrangement of the rollers makes it more convenient to move the rack 1. The rollers 11 in this embodiment are detachably connected to the bottom frame.

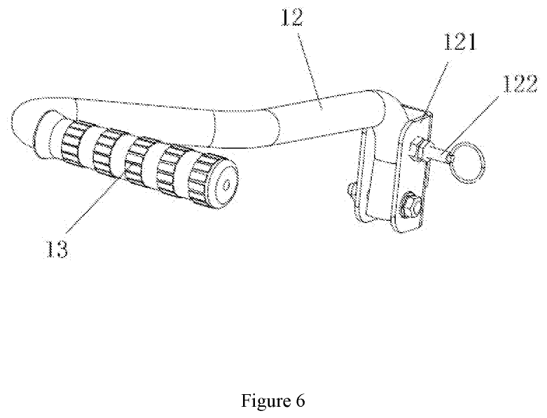

In a preferred embodiment of the invention, the hydraulic log splitter further comprises a handle 12, wherein the handle 12 is arranged at one end of the cutter 5, away from the push plate 6, and a non-slip sleeve 13 is sleeved around the handle. In this embodiment, the handle 12 is configured to push the rack 1 in an easier way. The non-slip sleeve 13 is provided that slip can be avoided, and it is easier for the user to hold the handle. As shown in FIG. 6, a handle connecting seat 121 is provided at one end of the handle 12, the handle 12 is connected to the cutter 5 through the handle connecting seat 121, the handle 12 is rotatably connected to the handle connecting seat 121. A limiting pin assembly 122 is arranged at one side of the handle connecting seat 121. The limiting pin assembly 122 comprises an outer sleeve, a stop pin, a spring and a tab, wherein the outer sleeve is secured to one side of the handle connecting seat 121, the stop pin is sleeved inside the outer sleeve, and one end of the stop pin passes through the outer sleeve and runs to the interior of the handle connecting seat 121, and the other end of the stop pin protrudes from the outer sleeve and is connected to the tab. The spring is sleeved on the stop pin, and the spring is fixed inside the outer sleeve. A limiting hole and a chute connected with the limiting hole are formed at one end of the handle 12. When using, one end of the stop pin extends into the handle connecting seat 121 under the action of the spring. When turning the handle 12 up, one end of the stop pin slides into the limiting hole though the chute, so that the handle 12 is secured in place, and the handle 12 and the handle connecting seat 121 are in an arrangement as shown in FIG. 6. When it is desired to put down the handle 12, one simply has to pull the tab, so that one end of the stop pin disengages from the limiting hole, the handle 12 automatically folds down under the action of gravity of the handle.

In a preferred embodiment of the invention, the hydraulic log splitter further comprises a reinforcing plate 504 and a bottom plate 505, wherein the reinforcing plate 504 is arranged at the inner side of the blade 501, the bottom plate 505 is arranged at a lower end of the blade 501, one end of the reinforcing plate 504 is connected to the bottom plate 505, and the other end of the reinforcing plate 504 is connected to one of the connecting plates 503. In this embodiment, the blade 501 is welded to the bottom plate 505, and one end of the bottom plate 505, close to the push plate 6, has a V-shaped structure, so that it is easier to push away the split wood. The reinforcing plate 504 is connected to the bottom plate 505 and the connecting plate 503 for supporting the blade 501, and for increasing the stability of the blade 501. Both ends of the reinforcing plate 504 are connected to the bottom plate 505 and the connecting plate 503 by welding.

In a preferred embodiment of the invention, the hydraulic log splitter further comprises a flange structure 14, wherein two flange structures 14 are disposed on both sides of the main beam 2, a plurality of raised strips 15 are provided in each of the two flange structures 14. In this embodiment, each of the flange structures 14 is inclined toward the rib structure 16 from top to bottom, and the split wood is separated from the main beam 2 in a direction from the surface of the flange structure 14 to both sides under the action of the push plate 6. A lower end of the flange structure 14 is bent down to form a bending portion, and the bending portion is removably connected to the main beam 2 by bolts.

In a preferred embodiment of the invention, the hydraulic log splitter further comprises a power unit 17, wherein the power unit 17 is arranged at the upper end of the rack 1;

wherein the power unit 17 comprises an engine 171, a hydraulic pump 172 and a connecting assembly 173, the engine 171 is arranged at the upper end of the rack 1, the connecting assembly 173 is sleeved on an engine shaft of the engine 171, and the hydraulic pump 172 is connected to the engine shaft through the connecting assembly 173, and the hydraulic pump 172 is connected to the oil tank 3 and the oil cylinder 4 through the oil pipe 7. In this embodiment, as shown in FIG. 2, the oil pipe 7 comprises a first oil pipe 701 and a second oil pipe 702. The hydraulic pump 172 is connected to the oil cylinder 4 through the first oil pipe 701, and the oil cylinder 4 is connected to the oil tank 3 through the second oil pipe 702. The first oil pipe is connected to the oil outlet and the hydraulic pump 172, and the second oil pipe is connected to the hydraulic pump 172 and the oil cylinder 4. The engine 171 is used to drive the hydraulic pump 172 to pump the hydraulic oil in the oil tank 3 into the oil cylinder 4. The connecting assembly 173 comprises a fixing frame 174; a first coupler 175 and a second coupler 176 arranged in the fixing frame 174; and an elastic member 177 arranged between the first coupler 175 and the second coupler 176. The fixing frame 174, the first coupler 175 and the second coupler 176, and the elastic member 177 are all sleeved around the outer edge of the engine shaft. In this embodiment, the end of the fixing frame 174, away from the engine 171, is fixedly connected to the hydraulic pump 172, the second coupler 176 is located at the end of the first coupler 175 away from the engine 171, and the hydraulic pump 172 is connected to the second coupler 176. The elastic member 177 is used for shock absorption, prevents the vibration force of the engine shaft from being transmitted to the hydraulic pump 172, and can increase the stability of the hydraulic pump 172 during its operation.

The above descriptions are only the preferred embodiments of the invention, not thus limiting the embodiments and scope of the invention. Those skilled in the art should be able to realize that the schemes obtained from the content of specification and drawings of the invention are within the scope of the invention.

What is claimed is:

1. A hydraulic log splitter, comprising a rack, a main beam, an oil tank, an oil cylinder, a cutter, a push plate and a rib structure, wherein the main beam is arranged at an upper end of the rack, the oil tank is arranged inside the main beam, one end of the main beam is connected to the rack, the other end of the main beam protrudes from the rack, an upper surface of the main beam is recessed inward to form a reinforcing rib structure having a V-shaped longitudinal section, the oil cylinder is arranged at one end of the main beam, the cutter is arranged at the other end of the main beam, the push plate is arranged between the cutter and the oil cylinder, the push plate is connected to a push rod of the oil cylinder, the plurality of rib structures are uniformly arranged at an end of the push plate, away from the oil cylinder, the oil cylinder is fixedly secured to a lower end of the main beam, and the oil cylinder is connected to the oil tank through an oil pipe.

2. The hydraulic log splitter of claim 1, further comprising: a support leg, wherein the support leg is removably mounted at the other end of the main beam for supporting the main beam, and a non-slip mat is arranged at a lower end of the support leg.

3. The hydraulic log splitter of claim 1, further comprising: a handle, a handle connecting seat and a limiting pin assembly, wherein the handle is arranged at one end of the cutter, away from the push plate, one end of the handle is connected to the cutter through the handle connecting seat, and the limiting pin assembly is arranged at one side of the handle connecting seat.

4. The hydraulic log splitter of claim 3, further comprising: two oil cylinder mounting bases which are symmetrically and fixedly disposed on two sides of one end of the main beam, the oil cylinder is fixed to the two oil cylinder mounting bases.

5. The hydraulic log splitter of claim 1, wherein the log splitter comprises a V-shaped blade and a hemming structure arranged at two free ends of the blade.

6. The hydraulic log splitter of claim 5, further comprising: a plurality of connecting plates arranged at an inner side of the blade, and two ends of each of the plurality of connecting plates are connected to the two hemming structures.

7. The hydraulic log splitter of claim 1, further comprising: a filter, wherein an oil outlet is provided at the oil tank, one end of the oil pipe is connected to the oil outlet, the other end of the oil pipe is connected to the oil cylinder, and the filter is fixedly arranged at an inner side of the oil outlet.

8. The hydraulic log splitter of claim 6, further comprising: a reinforcing plate and a bottom plate, wherein the reinforcing plate is arranged at the inner side of the blade, the bottom plate is arranged at a lower end of the blade, one end of the reinforcing plate is connected to the bottom plate, and the other end of the reinforcing plate is connected to one of the connecting plates.

9. The hydraulic log splitter of claim 1, further comprising: a flange structure, wherein two flange structures are disposed on both sides of the main beam, a plurality of raised strips are provided in each of the two flange structures.

10. The hydraulic log splitter of claim 1, further comprising: a power unit, wherein the power unit is arranged at the upper end of the rack;
wherein the power unit comprises an engine, a hydraulic pump and a connecting assembly, the engine is arranged at the upper end of the rack, the connecting assembly is sleeved on an engine shaft of the engine, and the hydraulic pump is connected to the engine shaft through the connecting assembly, and the hydraulic pump is connected to the oil tank and the oil cylinder through the oil pipe.
